(19) United States
(12) Patent Application Publication
(10) Pub. No.: US 2002/0166756 A1
(43) Pub. Date: Nov. 14, 2002

(54) Tilt sensor

(76) Inventor: Mitchell Lee Thompson, Exton, PA (US)

Correspondence Address: DUANE MORRIS LLP, 100 COLLEGE ROAD WEST, SUITE 100, PRINCETON, NJ, 08540-6604, US

(21) Appl. No.: 09/974,976

(22) Filed: Oct. 11, 2001

Related U.S. Application Data
(60) Provisional application No. 60/290,745, filed on May 14, 2001.

(51) Int. Cl. H01H 35/02

(52) U.S. Cl. 200/61.52; 340/689; 340/686.1; 200/61.45 R

(57) ABSTRACT

A tilt switch generates a signal as a function of orientation relative to a force, especially to detect tilting relative to vertical under the influence of gravity. A movable mass is mounted for displacement along a path between preloaded and unloaded positions. In the example of gravity tilt detection, a free-falling weight or an overbalanced inverted pendulum toggles by a mass falling back and forth between the preloaded and unloaded states. The weight is unstable and accelerates from the preloaded position to an unloaded position upon application of the force. A piezoelectric element such as a resilient strip is arranged to be deflected suddenly by the movable mass, and generates an electrical signal. The piezoelectric element can be mounted to obstruct the path of the mass. In the example of a pendulum toggle, the pendulum can have two angularly spaced legs that respectively move the piezoelectric element to opposite sides of its relaxed rest position between the preloaded and unloaded positions of the mass. The switch preferably is carried on a mounting structure that constrains the path of the movable mass and defines a directional reference.

This application claims the priority of U.S. provisional application Ser. No. 60/290,745, filed May 14, 2001.

The invention relates to an inclination-sensitive switch, and particularly to a piezoelectric tilt sensor with relatively movable parts that interact at a predetermined threshold angle of the switch, for producing a distinct electrical output suitable for use as a triggering signal.

A piezoelectric element, such as a thin strip of piezoelectric polymer, can be mounted according to the invention to interact with an overbalanced weight. The weight is mounted in an unstable manner relative to a base holding the polymer strip, such as a circuit card. The weight is constrained such that when the base is tilted to a critical angle, the weight falls by gravity and produces an electric signal via the piezoelectric strip, e.g., by striking the strip and/or by bending the strip due to contact or indirect transmission of force.

The amplitude of the signal produced by the piezoelectric element is due substantially to the energy of the falling weight. That energy does not change, for example, whether the base is suddenly inclined or brought very slowly up to the critical angle at which the weight falls. As a result, the sensor can produce a strong repeatable pulse signal over a range of tilting scenarios.

Preferably, the weight is mounted movably in a mechanism having extremes of motion that determine an angular hysteresis between the critical angle at which the weight falls and a resetting angle at which the weight is returned to a loaded unstable position for a new sensing cycle. The specific angles can be preset or adjustable. The motion of the weight can be constrained mechanically, for example by a hinge or pivoting linkage. A free weight can be placed so as to fall in a predetermined path or to fall along a defined track. Weighted elements can act directly or indirectly on the piezoelectric element.

Preferably a pivotal falling weight is arranged to strike directly against and to deflect a piezoelectric strip. The extent of such deflection can be increased by pre-loading the strip in the armed position of the sensor such that the weight moves the strip from a preloaded state through a rest position to a deflected state, thus increasing the amplitude of the signal obtained.

The sensor is particularly useful as an inexpensive but long-lived tilt sensor associated with a closure detector, such as a detector responsive to the opening of a horizontally hinged mailbox door, a pet door alarm or a similar closure having a tilting panel or other element. The sensor is also applicable to other movable elements, such as door panels and the like on vertical hinge axes, with the addition of a suitable linkage, cam, or inclined plane to provide a tilting coupled element to which the sensor can be linked.

### BACKGROUND OF THE INVENTION

Certain semi-crystalline polymers, such as polarized fluoropolymer polyvinylidene fluoride or “PVDF,” are known to have piezoelectric properties and have been employed in various sensors because they can be arranged to develop a voltage difference as a function of force or displacement. Depending on the structure, orientation and manner of deformation of the piezoelectric element, a useful voltage may be developed between electrical leads connected at different points to a body comprising piezoelectric material. The PVDF material might assume various shapes and configurations as appropriate. For example, electrical leads can be coupled to conductive polymer or metalized foil layers in a laminate or sandwich containing the PVDF piezoelectric material.

Polymer resin piezoelectric materials are particularly useful, for example, because the polymers can be embodied as sensing elements that are flexible and elastic, and develop a sense signal representing resiliently biased deformation when subjected to a force. In the case of a PVDF piezoelectric polymer, the piezoelectric sensing element is advantageously embodied as a thin strip. The piezoelectric material is oriented and two or more points of electrical contact with the material are arranged, such that when the strip is deflected, e.g., stretched or compressed, a voltage signal is produced. The voltage signal is produced because deformation of the polymer material changes the relative positions of charges in the polymer chain or semi-crystalline lattice structure. Such sensing elements are useful over a range of frequencies, for example from direct current levels up to ultrasound alternating current signals, and can be used in other contexts entirely, such as sensing temperature level. Sensing elements as described are available from Measurement Specialties, Inc., 950 Forge Avenue—Bldg B, Norristown, Pa. 19403 (http://www.msiusa.com).

In a situation pertinent to the present application, a thin piezoelectric polymer strip can produce an output signal when the strip is bent. Bending of an elongated shape such as a strip may involve tension and compression on opposite sides of a centerline extending along a bending arc (or neutral axis). A net piezoelectric effect can be obtained by structuring the device to produce a net effect of tension or compression. For example, the piezoelectric material can be placed away from the neutral axis of a structural beam or strip, in which case, bending of the beam or strip along the neutral axis results in net tension or compression of the piezoelectric material. Whether the effect is one of tension or compression depends on whether the piezoelectric strip is towards or opposite from the center of bending curvature relative to the neutral axis. Other structures are also possible, such as a structure in which discrete portions of piezoelectric material are differentially stressed but also are connected at opposite polarities to an apparatus responsive to their electrical outputs.

In an application associated with tilting, U.S. Pat. No. 4,814,753—Coppola provides weights mounted on a structure containing piezoelectric transducers to detect tilting. A simple tilt sensor could comprise a bendable resilient strip comprising a piezoelectric polymer and forming a depending pendulum with a weight attached at a free end. Such a tilt sensor not only measures tilt in a static sense, but also can sense “tilt” in the sense of lateral forces such as dynamic inertial forces from vehicle cornering, etc.

In order to produce the required electrical output, the force being detected needs to stress the piezoelectric material, generally causing some deformation that generates a current or potential difference due to the piezoelectric nature of the material. Piezoelectric materials may be useful in this manner for developing an electric signal that is proportional to a detected force. A similar application is to detect and signal a momentary occurrence, as opposed to sensing a force level. Instead of encoding signal strength, the signal is applied to some form of threshold detection trigger.

A familiar device that produces a contact closure output suddenly when the orientation or attitude of the device exceeds a threshold angle, is a sealed liquid mercury switch. A drop of liquid mercury is hermetically sealed in a glass vial whose walls are traversed at least at one end by spaced electrical contacts. When the orientation of the vial causes the liquid mercury to fall by gravity into the end of the vial containing the two spaced contacts, the contacts become immersed in the mercury, wetted and placed in electrical contact through the liquid mercury. When the glass vial is tipped toward the opposite end, the drop of mercury falls away and the electrical contact is opened. Surface tension holds the liquid mercury in a cohesive ball that falls suddenly from end to end within the sealed glass vial.

Mercury switches as described are simple and inexpensive and are used in various tilt sensing applications. In an on/off wall toggle switch, for example, a mercury switch can be attached to the on/off toggle lever operator, so as to tilt the mercury switch and close an electrical circuit when the toggle is in the “on” position and to break the circuit in the “off” position.

Thermostatic switches sometimes comprise a mercury switch mounted on a bimetal spring element that bends due to differential thermal expansion. The bimetal tilts the switch as a function of temperature and at a predetermined point causes the switch contacts to close. In a controllable thermostat the bimetal is carried on a rotatable mounting for setting the tilt angle and temperature at which the switch contacts are closed. Mercury switches also can be mounted to detect the displacement of movable parts such as the opening of a door, where the mechanical motion to be detected is converted by some mechanism into tilting of the switch.

A problem with mercury switches is that mercury is a poisonous heavy metal that cannot safely be released into the environment, in part because it accumulates in animals and fish. It is not recommended to dispose of mercury switches in landfills because their glass vials can be broken easily, leading to leaching of mercury into the ground water. Production facilities where mercury switches are made or installed can become polluted by spills. Protections are needed to prevent long term exposure of workers to mercury. It would be advantageous if the dependability of mercury switches could be achieved without the risk of pollution or injury.

The present invention concerns a tilt switch. It is known to provide a switch that throws upon opening of a horizontally hinged door such as the pivoting door of a suburban type mailbox. A switched signal generated by tilting of the door from a normally closed vertical position to an inclined (e.g., horizontal) open position signals that the door has been opened. This indicates, by implication, that mail is likely to be waiting to be picked up.

A limit or contact switch that engages between the movable door and the stationary mailbox body might sense opening of a mailbox door. Alternatively, opening can be sensed by a tilt sensitive switching apparatus associated with the mailbox door. Examples of mailbox door switching devices are disclosed, for example, in U.S. Pat. Nos. 6,046,675—Hanna; 5,023,595 —Bennett; 4,872,210—Benages; 4,868,543—Binkley, etc. A list of problems associated mailbox alarms is provided in U.S. Pat. No. 5,440,294—Mercier et al. These patents as well as the foregoing tilt sensitive Coppola patent are hereby incorporated.

It would be advantageous to provide a toggling or overbalance type tilt signaling element that is highly dependable and capable of surviving many operations over a long time. In a mailbox door and in similar consumer applications, it is important that the device be very low in cost, including requiring minimal installation or adjustment. In an occurrence detection application, the sensor should develop a robust and easily detected signal with a sharp transition, even if the detected occurrence may have been relatively weak or may have occurred slowly.

### SUMMARY OF THE INVENTION

According to the present invention, an improved sensing device and associated apparatus is provided by a tilt switch that generates a signal as a function of orientation relative to a force, especially to detect tilting relative to vertical under the influence of gravity. A movable mass is mounted for displacement along a path between preloaded and unloaded positions. In the example of gravity tilt detection, a free-falling weight drops, or an inverted pendulum is overbalanced, or an unstable weight is otherwise freed to operate on a piezoelectric element. The device toggles as the mass falls back and forth between the preloaded and unloaded states. The weight is unstable when changing states and accelerates from the preloaded position to an unloaded position upon application of the force. A piezoelectric element such as a resilient strip is arranged to be deflected suddenly by the movable mass, and generates an electrical signal. The piezoelectric element can be mounted to obstruct the path of the mass. In the example of a pendulum toggle, the pendulum can have two angularly spaced legs that respectively move the piezoelectric element to opposite positions spaced on either side from a relaxed rest position, the opposite positions of the piezoelectric element corresponding to the preloaded and unloaded positions of the mass. The switch preferably is carried on a mounting structure that constrains the path of the movable mass and defines a directional reference.

The mass or weight and its mounting can be structured for guiding the mass back and forth between the unloaded position to the preloaded position, with an angular hysteresis as needed to overbalance the mass toward one position or the other. According to an alternative embodiment, the mass or weight can be free falling, or as a further alternative, the mass can fall within a constrained guide track.

The invention is particularly applicable as a toggling gravity-operated tilt switch, similar in operation to a liquid mercury switch. Thus the invention is useful at least in the same sort of applications as a mercury switch. These applications include, without limitation: producing a signal upon movement of a manually or automatically moved or tilted part such as a toggle switch operator; switching upon tilting a temperature sensitive bimetal strip for sensing temperature variations: responding to inertial forces: triggering an output as a function of a door or vehicle hood or trunk position, such as an access light, or to activate a freezer-door light switch; generating an alarm or switching off a heater or similar device that falls over, such as space heaters, fabric irons or the like; operating flotation and level controls and sensors, leveling devices or aids, producing motion and disturbance alarms and the like. The invention is also useful in other situations to sense and signal application of a directional force. As with a mercury switch, there are various applications in which the device may be fixed relative to an applied force, or alternatively, one of the force or the switch mounting can be movable relative to the other, changeable in orientation or amplitude, and/or adjustable with respect to one or more such aspects.

In a preferred arrangement, the signal is generated by impact of the movable mass against the piezoelectric element. Preferably the impact is arranged to occur after the mass has accelerated along the path, from the preloaded position to the point of impact, due to application of the force to the mass while the mass accelerates along the path and thus accumulates kinetic energy.

In the case where the force is gravity, overbalancing permits the force to accelerate a previously restrained mass. The force of gravity, which is fixed in direction and amplitude, is effectively switched into operation when the device is overbalanced. The fixed force of gravity accelerates the mass at a precise rate. The energy released by the impact is determined by inertia, namely by the product of mass and speed. The device generates a robust and highly repeatable signal even though the device might have been tilted suddenly or might have been brought very slowly up to the angle of inclination at which the weight is overbalanced. Similar advantages result when the invention is applied to other forces or situations with similar attributes.

The change in tilt or inclination needed to operate the device is relative rather than absolute. The switching apparatus or the force, or both, might be movable or changeable in orientation to overbalance and release the mass for acceleration. The switching apparatus can be embodied in or attached directly to a movable part, or mechanically coupled such that the necessary movement is imparted. In an exemplary embodiment, the invention is applied in to detect the opening of a door panel. In a simple situation with a panel hinged on a horizontal axis, such as the door of a suburban-type mailbox, the switch can be attached rigidly relative to the tiltable door. In other situations, such as vertical hinge panels and the like, a linkage can convert a mechanical movement (e.g., pivoting on a vertical axis) into tilting of the sensor apparatus of the invention on a horizontal axis for generating a triggering signal.

The piezoelectric element can comprise or form part of a resilient strip that is bent from a rest position of the strip, by movement of the mass and preferably due to impact from the mass, so as to produce an electrical signal. In an alternative embodiment the resilient strip is also preloaded. That is, in the preloaded position of the mass, the resilient strip is biased in a direction opposite from the position in which the strip is moved under influence of the mass. This increases the amplitude of the signal by increasing the extent of displacement applied to the piezoelectric element.

The movable mass can be arranged over a pivot axis, defining an inverted pendulum by which the movable mass is moved between the preloaded position and the unloaded position by overbalancing the pendulum in a plane perpendicular to a pivot axis of the pendulum. A supplemental extension can be coupled to the pendulum or associated with the pendulum for affecting movement of the pendulum (e.g., determining the endpoints of movement) or the movement of the piezoelectric element (e.g., pre-loading the piezoelectric element for increasing the signal amplitude as described.

### BRIEF DESCRIPTION OF THE DRAWINGS

These and other features, aspects, and advantages of the present invention will become more fully apparent from the following description, appended claims, and accompanying drawings in which:

FIGS. 1 and 2 are schematic representations of a sensor according to a first embodiment of the invention, embodied as a tilt-responsive gravity toggle switch shown upright and tilted in FIGS. 1 and 2, respectively.

FIGS. 3 through 5 are elevation views of an alternative embodiment, showing successive stages in operation of the tilt responsive apparatus of the invention.

FIGS. 6 through 8 are elevation views corresponding to FIGS. 3-5 and showing stages in the recovery or reset of the apparatus leading to a further switching cycle.

FIGS. 9 and 10 respectively illustrate a further alternative embodiment in upright-armed and tilted-discharged states.

FIGS. 11 and 12 illustrate two further alternative embodiments in upright-armed and tilted-discharged states, respectively.

FIG. 13 is a schematic diagram showing an interface circuit for application of a piezoelectric element.

FIG. 14 is a time trace of voltage versus time at the FET drain output SIG of the embodiment shown in FIG. 13.

FIG. 15 is a perspective view showing integration of the tilt sensing apparatus with a printed circuit (PC) board.

FIG. 16 is a plan view showing a PC board mounted embodiment of the apparatus.

FIG. 17 is an elevation view showing the combination of the apparatus and a mailbox door position sensor.

### DETAILED DESCRIPTION OF THE PREFERRED EMBODIMENTS

In a general sense, the apparatus of the invention provides an electrical sensor responsive to an excitation force and a mechanism that applies the necessary excitation force to the sensor under certain conditions, and resets in the absence of the condition. A preferred application of the invention develops a signal representing the orientation of the apparatus relative to vertical, is powered by gravity, and is triggered by overbalancing a mass. The mass falls and accelerates over a path leading to impact against a sensing strip that develops an electrical signal, preferably a piezoelectric element.

The preferred gravity-driven tilt sensitive application is intended to be exemplary rather than limiting. Thus, directional expressions and the like in this disclosure such as “up” and “down,” etc., are used for convenience in describing the examples shown and with reference to gravity as the operative force, but do not exclude other directions, other directional forces and the like in a comparable device for another application.

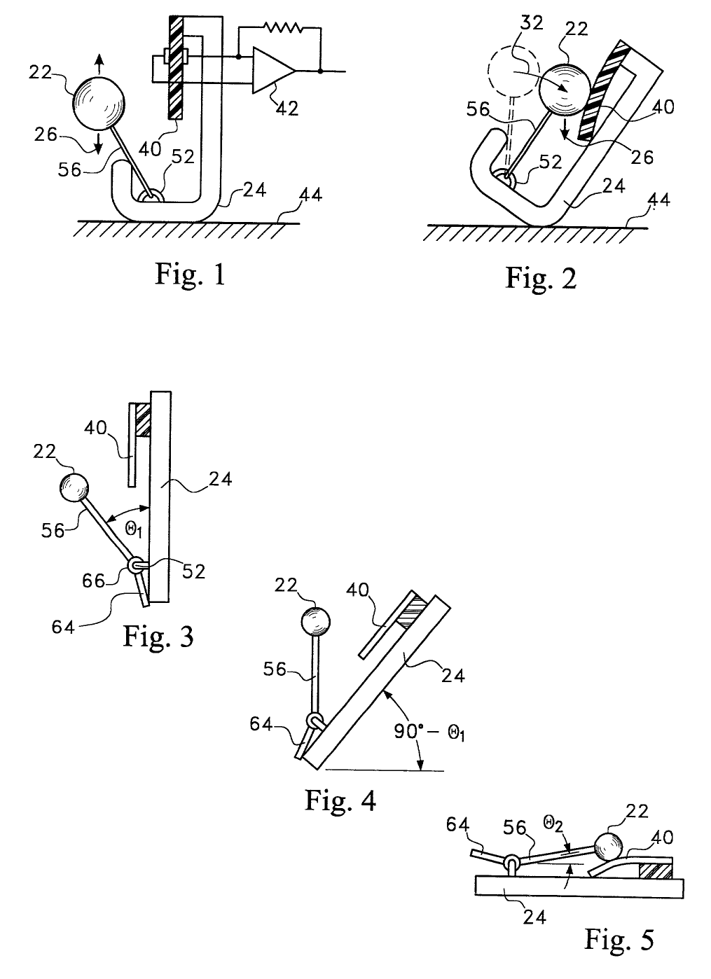

FIG. 1 illustrates the invention schematically. A mass 22 is movably mounted on a base member 24. The mass 22 could be attracted or repelled by any directional force, but in the illustrated embodiment of a tilt sensor, the movable mass 22 is attracted vertically toward the earth by gravity, shown by arrow 26. The mass has a certain amount of potential energy when poised to fall. In accelerating while falling, the mass develops kinetic energy that can be imparted to the sensing strip to produce the output signal.

In FIG. 1, the mass 22 is shown in an unstable preloaded position. As shown in FIG. 2, the mass 22 is mounted for displacement along a path 32 from the unstable preloaded position, now shown in broken lines, to an unloaded position, shown in solid lines. Mass 22 is free to move under influence of the applied force 26, provided that the relative orientation of the base 24 and the force 26 is beyond a certain critical angle as shown. In the case of the tilt sensor, the force is applied to move the mass 22 from the preloaded position toward the unloaded position by tilting the base 24 of the apparatus to a critical angle that causes mass 22 to fall from one position to the other.

A piezoelectric element 40 is provided to generate an electrical potential when deflected by movement of the mass 22. The piezoelectric element 40 as shown in FIGS. 1 and 2 is mounted so as bend upon displacement of the mass 22 along the path 32. In this example the mass 22 strikes the piezoelectric element 40 directly, when the mass 22 is overbalanced by tilting of the base 24 of the apparatus, and falls against the piezoelectric element 40.

The piezoelectric element 40 can be a polarized fluoropolymer sensing strip, such as polyvinylidene fluoride or “PVDF.” The piezoelectric element develops an electrical signal in known manner due to the rearrangement of internal charges within the material. When the strip is composed of a piezoelectric element laminated to a surface of a stiffer lamina material that holds the piezoelectric element substantially to one side of a neutral axis as the laminate is bent, for example, charges are compressed together (on the inside of the bending radius) and/or stretched apart (on the outside), and a voltage is developed that can be used as a triggering signal. The signal can drive a switching element such as an amplifier 42, shown schematically in FIG. 1, having an output that is processed as needed. The amplifier 42 or other signal processing device as shown in FIG. 1, is not shown in most of the remaining figures, but some sort of amplifier or device responsive to the signal generally can be inferred.

The apparatus has a mounting structure that constrains the movable mass 22 to move between the preloaded position and the unloaded position. Various structures are possible and FIGS. 1 and 2 show one example. Several other examples are discussed hereinafter. In the preferred tilt sensor application, the mounting structure or base 24 is movably oriented relative to the earth 44 so that the mass 22 can fall from the preloaded position shown in FIG. 1 (or in broken lines in FIG. 2) to the unloaded position shown in solid lines in FIG. 2. In this embodiment the falling mass 22 directly strikes the piezoelectric element 40 to generate the electrical output signal.

It is possible to envision a one-operation sensor wherein a weight falls against a sensor and is never reset. However, the base or mounting structure 24 preferably is arranged to guide the movable mass 22 back from the unloaded position to the preloaded position for successive operation, i.e., the mass 22 is captive and is movable in both directions with some angular hysteresis. It is also possible to envision a sensor that is structured as shown but which responds to an intermittent force as opposed to a fixed force (e.g., gravity) with a variable orientation (tilt). In the preferred example of a tilt sensor, the force is constant and directional, such as gravity, and the mounting structure 24 and the force are relatively movably oriented. Comparing FIGS. 1 and 2, the mounting structure 24 constraining movement of the mass 22 is tiltable relative to vertical, thereby altering the relative direction of gravity and causing the mass to be moved from the preloaded position to the unloaded triggered position, for causing an impact with the piezoelectric element 40.

The mass 22 is free falling relative to the piezoelectric element 40 but both are connected to the same base 24 and the path of the mass is constrained. In the embodiment shown, the common support 24 provides a pivot or hinge axis to support a mass 22 in the form of an unstable inverted pendulum. The changing orientation of the force (e.g., gravity) can overbalance the pendulum to cause mass 22 to toggle back and forth.

The piezoelectric element 40 in the embodiment shown is at least part of a resilient strip having a rest position in which the strip is substantially straight. Impact from the mass 22 bends the strip from the rest position to produce the output signal. The mass 22 is arranged vertically above a pivot axis 52, defining the inverted pendulum. The pendulum is stable if the mass is permitted to fall to either side of the pivot axis, which is determined by whether the center of gravity of the mass is on one side of the pivot or the other. On one side, mass 22 strikes the piezoelectric strip 40. On the other side, in the embodiment of FIGS. 1 and 2, the base 24 defines a stop for the arm 56 of the pendulum. In FIGS. 3-8, a tail part 64 of the pendulum engages the base 24, which can be a printed circuit card or the like, to define a limit. Alternatively, the pendulum arm 56 can be free to swing widely in that direction.

FIGS. 3 through 8 illustrate stages in operation of an exemplary embodiment wherein the invention functions as a tilt switch. In the embodiment shown, a pendulum-pivoted mass 22 is carried on a base 24 such as a printed circuit (PC) board by means of a hinge pin fixing the pivot axis 52 of the pendulum, adjacent to the surface of the PC board. The hinge axis 52 can be defined by a wire body similar to a staple, affixed mechanically or soldered to the PC board.

The arm portion 56 of the pendulum is arranged to pivot on the pivot axis 52, for example being wrapped helically around the wire forming the hinge axis. According to an inventive aspect, at least one supplemental extension or tail 64 is coupled to the pendulum. The tail 64 can extend from the helical wrapping 66 by which the pendulum is mounted on the hinge axis 52. The tail 64 limits the extent to which the pendulum arm 56 can pivot away from the circuit board, defining a maximum angle θ1 as shown. The tail or extension 64 in FIGS. 3-8 extends from the pivot axis in a different direction from that of the pivot arm 56, such as a diametrically opposite direction, thereby limiting the angle of the pendulum arm by bearing against the front side of the PC board. The tail could also form an acute angle with the pendulum arm 56 and bear against an opposite side of the PC board base member 24.

By restricting the range of movement of the mass 22 between the preloaded and the unloaded positions to a maximum angle, the energy expended by mass 22 falling against the piezo strip 40 is substantially fixed. The tail 64 or other restriction determines the preloaded position by setting the maximum angle θ1 that can be assumed by the pendulum arm relative to the plane of the PC board.

In FIGS. 3-8, it is assumed that the active force is gravity and acts in a vertical direction relative to the page. In the orientation of the PC board shown in FIG. 3, the center of gravity of mass 22, carried on pendulum arm 56, is to the left of the hinge axis 52. As a result, gravity acts to rotate the pendulum counterclockwise.

The tail 64 of the pendulum acts as a backward stop to fix the maximum angle θ1 and the maximum distance of the mass from the sensor strip. Adjusting the position of the backward stop or tail 64 can vary this angle. A relatively larger angle θ1 causes the mass to fall a longer distance to strike the piezo strip 40, which causes the mass to strike harder and may generate a higher amplitude signal. However if the angle θ1 is large, there also is a large hysteresis angle required for the device to reset, which will be appreciated from the further figures. A large hysteresis angle may be undesirable unless the application is such that the device is assured of cycling through a sufficient angle to move the mass back to the preloaded position shown in FIG. 3 after each operation wherein mass 22 falls against the piezo strip 40.

If the PC board is rotated clockwise from the position shown in FIG. 3, it will reach a position as shown in FIG. 4, wherein mass 22 is directly over the pendulum hinge axis 52. The mass 22 is then unstable and further rotation of the PC board in a clockwise direction from this position, places the center of gravity of the mass 22 to the right side of the of the hinge axis 52 and causes the mass to fall toward the piezo strip.

The output signal is produced substantially when the mass 22 first falls against the piezo strip 40. The base 24 (e.g., a PC board) can be advanced to a horizontal orientation as shown in FIG. 3 for each operation, but need not be advanced beyond the point at which the mass 22 falls. Similarly, base 24 could be rotated past horizontal, without any adverse effect.

The mass 22 strikes the piezo strip 40 after falling through an angle that is approximately equal to angle θ1. The precise falling angle is less then θ1 by the standoff height of the piezo strip 40 above the PC board or other base 24. The span of the falling angle is increased slightly if the PC board is rotating continuously, because in that case the PC board continues to advance during the time that the mass 22 is falling. Nevertheless, the device is relatively insensitive to the speed of tilting of the PC board because the energy applied is substantially due to the acceleration of the mass while the pendulum falls through angle θ1. The mass 22 commences to fall after the least rotation clockwise beyond the position shown in FIG. 4.

The amplitude of the signal output from the piezo strip 40 is a function of the extent of its deflection. The mass typically strikes the piezo strip and bounces resiliently to some extent, producing a series of peaks. Depending on the needs of the circuit, it may be advisable to condition the signal, for example by using the signal to set a flip-flop or to trigger a one-shot (not shown), or otherwise to produce an output that persists longer than the maximum time that the mass might bounce against the strip.

In FIG. 5, where the PC board is shown at horizontal, the standoff height of the mounting for the piezo strip 40, holds the mass slightly above the surface of the PC board and also above the height of the hinge axis 52. There is a small angle θ2 between the pendulum arm and horizontal. This angle θ2 affects the position of the “untoggle” event, and the angular hysteresis needed to cycle through successive operations of the device.

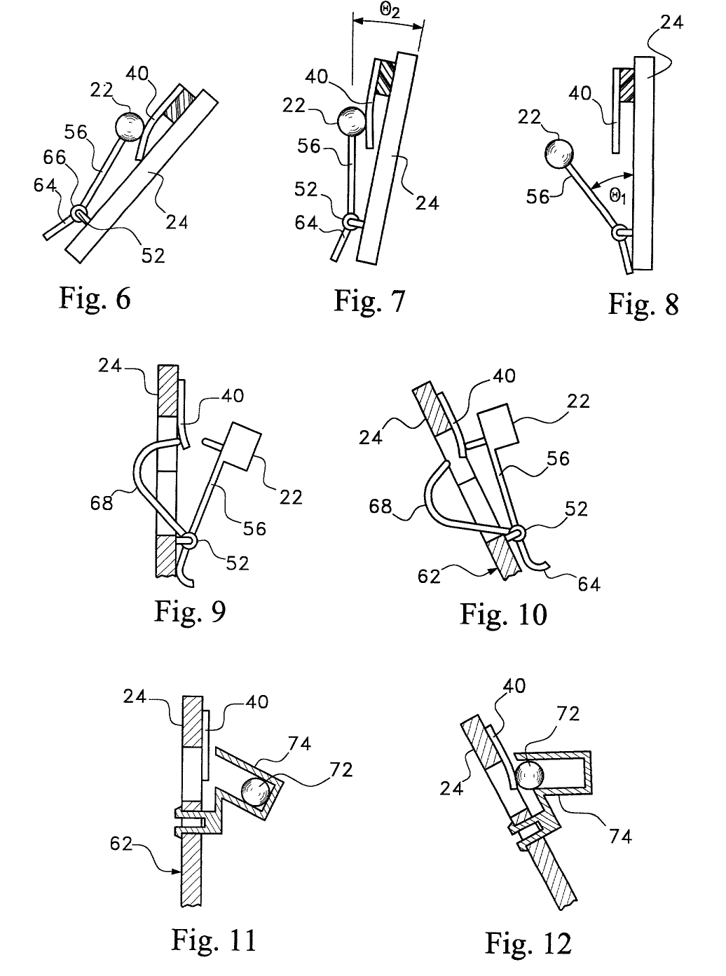

In FIG. 6, the PC board is being tilted back again in a counterclockwise direction toward the starting position shown in FIG. 3. At this point, the piezo strip 40 is still depressed. However, the vector component of the weight applied in a direction perpendicular to the PC board is decreasing as the angle of the PC board increases.

Eventually the PC board is rotated counterclockwise to the point where the center of gravity of mass 22 is precisely vertical over the hinge axis 52 and the pendulum is again unstable (FIG. 7). At this point, the PC board is tilted or inclined in a clockwise direction by angle θ2 relative to vertical. The mass falls away from the piezo switch, thereby toggling and re-arming the switch. When the mass is lifted from the piezo strip, a reverse polarity output can occur.

In FIG. 8, the PC board is aligned again at a vertical orientation as in FIG. 3, with the mass arranged at angle θ1 relative to the PC board. This is a convenient starting position for the switch because the PC board is vertical. However the starting position could be anywhere from just counterclockwise from the position shown in FIG. 7, to a position in which the PC board is inclined further counterclockwise relative to vertical.

In using the device as a tilt switch, it is advantageous to ensure that the device will reset. If there is some question as to whether the PC board will be brought all the way to vertical, the dependability of the reset can be improved by increasing the value for θ2, namely by providing a higher standoff for the piezo strip. On the other hand, the force at which the mass 22 strikes the piezo strip 40 is related to the difference between θ1 and θ2, and to maintain a given force, one might increase angle θ1 and/or decrease θ2. The drawback in that case is that the switch does not operate until the PC board is inclined to angle θ1, so that increasing θ1 also increases the dead space in the tilt sensing function. In some applications a large dead space is desirable and in other applications a small or substantially eliminated dead space may be desired. The dead space can be increased or decreased and the angular point of operation can be varied, with effects on signal amplitude and reset position that are apparent from the foregoing discussion.

In the embodiment shown, θ1 is about 40 degrees and θ2 is about 5 degrees. This provides a strong signal when the PC board is inclined to 40 degrees or more, and is acceptable provided that there is a high probability that the PC board will be brought to at least 5 degrees of vertical. These angles are apt for a door sensor on a suburban mailbox, for example, because it is normally necessary to open the door by more than 40 degrees to insert or remove mail, and the door of the mailbox is almost always fully closed between accesses, as needed to protect the contents from the weather and often also to cause the door to stay shut.

FIGS. 9 and 10 illustrate a different form of supplemental extension 68 on the pendulum, in this case arranged to preload the piezoelectric element 40. The supplemental extension provides a second leg, angularly spaced from the arm 56 of the pendulum carrying the mass 22. As shown in FIG. 9 (which corresponds to the loaded position shown in FIGS. 3 and 8), the supplemental leg of the pendulum reaches to the back side of the piezo strip 40 and lifts the piezo strip above its rest position in the loaded or armed state of the device. When the PC board (or other base) 24 is tilted to the critical angle, impact of the mass 22 against the strip 40 moves the strip through a span of displacement from above the armed state, through the rest position to the deflected position shown in FIG. 10. This increases the amplitude of the signal produced by the piezo strip by bending it through a greater span between the preloaded (armed) and unloaded (discharged) states.

The embodiment in FIGS. 9 and 10 comprises a pendulum with two angularly spaced legs 56, 68, one of the legs carrying the mass 22 and another of the legs operating in the preloaded position of the mass to bend the piezoelectric element 40 in said direction opposite from the direction of displacement. It should be appreciated that the mass 22 could be carried wholly or partly on either or both of the legs 54, 68, which are fixed to one another in this embodiment, with the same effect.

In the foregoing embodiments, the mounting base 24 carrying the tilt-sensing device has been a PC board. It is advantageous to mount the piezo element and the mass directly on a PC board, but it is also possible to package the tilt sensor as a separate device that is attached onto a PC board. In that case, the angle of the tilt sensor can be set independently of the angle at which the PC board is mounted, which is advantageous in some installations.

FIGS. 11 and 12 illustrate two embodiments in which free falling weights 72 are captive in structures 74 defining tubular guide tracks that permit the weights (masses) 72 to fall against piezo strips 40. These embodiments are arranged such that the piezo element is mounted flush on the surface of the PC board (or other base defining element) 24, for example at a depression or through opening. The track structure constraining the path of the weight is surface mounted. In FIG. 11, the track structure defines a blind-end tube that holds a ball bearing or the like. The weight is captive when the device is assembled. The clearance between the track and the PC board, and the stiffness of the piezo element, are such that the ball bearing remains captive. Accordingly, the device operates much the same as the pendulum embodiments discussed above.

The captive-weight devices of FIGS. 11 and 12 hold the weight in an unstable manner so as to be dropped against the piezo strip when the critical tilt angle is reached. However these embodiments have little angular hysteresis. In FIG. 11, for example, the critical angle is the point at which the axis of the track tube 74 is horizontal. If the device is inclined slowly up to horizontal, the weight can be rolled gently against the piezo strip, producing a low amplitude signal, or at least a signal having a low slew rate. If the device is inclined by even a small angle in either direction relative to horizontal, the weigh will roll downwardly with the only limitation being friction.

Hysteresis can be added to these embodiments by modifying the structure of the track. In FIG. 12, a blind tube has a difference in slope angle along its length (steeper adjacent to the piezo strip), which provides a hysteresis tilt angle in connection with resetting, because the inclination needs to be greater to move the weight back into the tube from the position shown than to roll in the tube. Other angular variations are possible, including arrangements that have different angles at different positions along the track, or optionally are smoothly curved. It is also possible to provide a ridge (not shown) or the like as a detent that holds the weight in the tube until the angle of inclination is sufficient to pass the weight over the ridge, which permits a sudden falling of the weight similar to the situation of an overbalanced pendulum. The embodiments of FIGS. 11 and 12 can be mounted, for example using a snap-in bayonet pin with hooked legs as shown in FIG. 11, to engage at a hole in the PC board (FIG. 11).

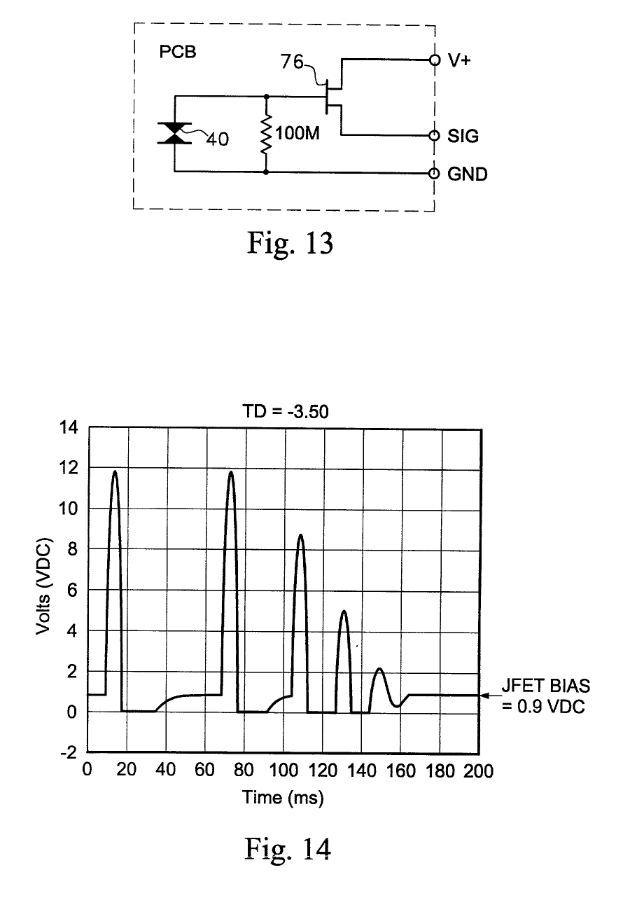

FIG. 13 illustrates an exemplary interface circuit for coupling the piezo element to a switching or amplifying circuit. The piezo element 40 is preferably coupled to drive a JFET 76 for switching the output line to the potential of the power supply V+when the piezo charge exceeds a threshold. The piezo element is coupled to the gate of the JFET with a large parallel resistance of 100 MΩ. Assuming a 12-volt power supply, and a 1 MΩ input impedance oscilloscope input, the resulting signal output produced is shown in FIG. 14, using the embodiment of FIG. 9. The output produces strong peaks followed by decreasing bounce as the weight settles mechanically against the piezo strip.

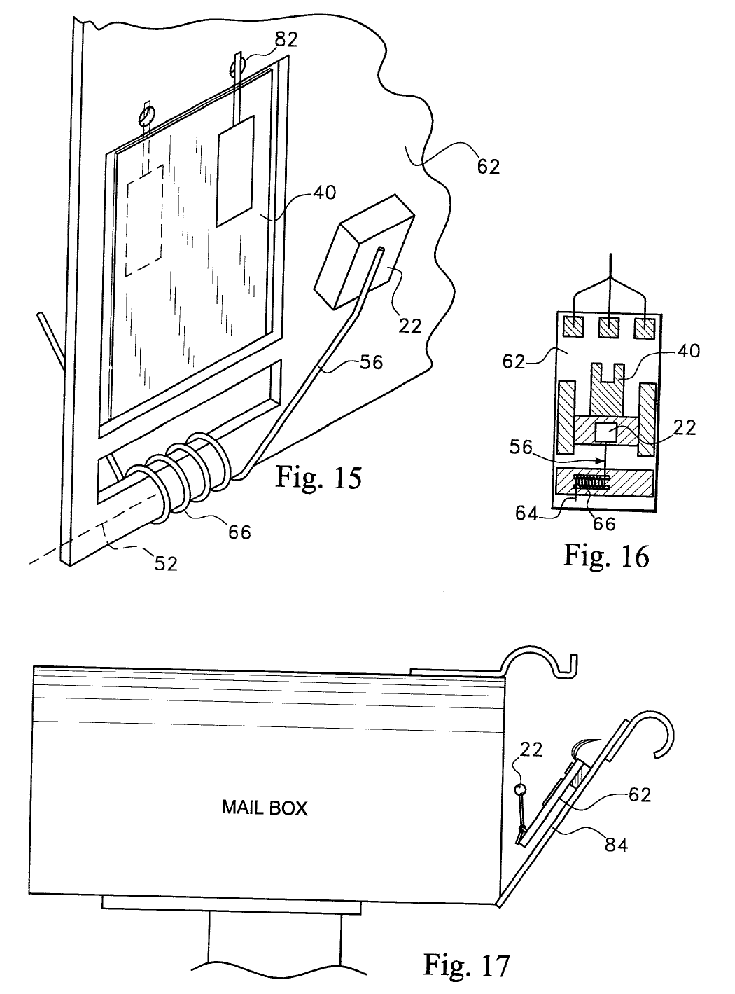

FIG. 15 illustrates a simple PC board mounting. The mass 22 can be carried on a pendulum formed by an extending arm of a helical spring, wrapped on an elongated strip of the PC board, with the backstop tail of the pendulum bearing against the PC board to hold the appropriate maximum angle. The piezo element is mounted at a defined opening, for example by the same leads used to make electrical connections with the circuit.

As shown in FIGS. 16 and 17, the invention is apt for a mailbox door alarm. The tilt sensor can be mounted on a PC board as shown in plan view in FIG. 16 and in side elevation in FIG. 17. The maximum and minimum tilt angles of the door are such that the limit angles discussed in FIGS. 3-8 are appropriate.

According to an inventive aspect of the embodiments discussed above, a piezoelectric sensing element is used to sense tilting. In a preferred arrangement, the amplitude of the signal need only reach a sufficient level to meet the threshold of a triggered circuit, although it is conceivable to discriminate by amplitude. The triggered circuit could be a digital switching element such as a one shot or a flip flop, an amplifier circuit input he input of a digital logic element or an operational amplifier. It is possible to conceive of a measurement device in which tilting of a structure is caused to deform a piezoelectric sensing element that is coupled between movable parts so as to develop a signal that varies with the degree of tilting of the structure. For example, a pendulum could be arranged so as to bend a piezoelectric element coupled to a support, by an amount that is a function of tilt as represented by the relative positions of the pendulum versus the support over a measurement range.

The preferred arrangements have the further threshold responsive aspect that a momentary type signal is produced when tilt has exceeded a threshold, as opposed to measuring a degree of tilt. Accordingly, the invention produces a signal that occurs in a momentary or digital fashion immediately when the orientation of a sensing element exceeds a threshold. The preferred signal is produced by causing sudden excitement of a piezo element upon releasing stored potential energy from a falling weight. The weight is mounted so as to toggle operation between preloaded (armed) and unloaded (fired) states.

This gravity based toggling apparatus, and the method it embodies, have a number of advantages over known piezoelectric sensing devices, which typically have masses affixed to an end of a piezoelectric element or are arranged to provide a continuous range of output amplitude over a continuous range of excitation parameters. The apparatus and method are applicable to many of the same applications as a mercury switch, without the environmental dangers, although the invention does not produce a direct contact closure unless employed with a circuit that is triggered to switch contacts as its output.

The momentary toggling arrangement as discussed has a number of advantages over such continuous measurement devices. Inasmuch as there is a mechanical threshold involved, the device has very low sensitivity to influences such as vibration and temperature variation. The output signal need not be proportional or otherwise linearly related to input conditions, so sensitivity and linearity or other measures of precision are generally not needed. As a result the device can be quite inexpensive. The piezo strip can be short. The mass, the mounting and the like need not be manufactured to high tolerance. There are no calibration requirements. The mechanism is robust and durable enough to survive and function through a high number of operational cycles.

The piezo strip (sometimes known as a “beam,” particularly as mounted alongside a neutral axis to maximize net electrical output) can be shorter in the tilt application described than its equivalent LDTM (a laminated series of piezo film sensors with lead attachments such as LDTM-028K, part no. 0-1005447-1, manufactured by Measurement Specialties Inc.). A short-beam sensor strip is relatively stiff (compared to a longer beam of otherwise similar material and dimensions). The short beam has a relatively high resonant frequency, which frequency is a component of the signal obtained when the mass hits the sensor beam. This lowers the value of the required input impedance for a given cutoff frequency. In order to obtain substantially equivalent sensitivity using a traditional LDTM approach, the beam would need to be significantly larger and less stiff, requiring high input impedance in the signal processing stages.

The device of the invention can perform many of the functions of liquid mercury switches, including switching functions with the addition of inexpensive switching devices triggered by the signal from the piezoelectric strip. These include, among other examples, the various switching and sensing functions associated with manual controls, thermostats, position sensors, automatic hatch light switches, motion or disturbance alarms, fall-over cutoff circuits, and the like. However there is no mercury or other toxic constituent involved, making manufacture, and eventual disposal simple, safe and inexpensive.

The device of the invention has no electrical contacts to make and break. Therefore, there are no surfaces that can foul, pit, corrode, tarnish, or otherwise deteriorate over time. Although the device has two movable parts (the hinged pendulum and the bendable strip), there is little concern with corrosion. The polymer form of piezo element is environmentally resistant, particularly if normally protected from ultraviolet light (i.e., coated or mounted where not subjected to sunlight). Bending of the strip can continue over a long useful life. In the embodiment with a pendulum mounted mass, the hinge or pivot of the pendulum might represent an area concern regarding corrosion. However the mass tends to overcome any resistance engendered by expected corrosion. The effect on operation is less critical, for example, than potential loss of continuity associated with deteriorated switching contacts in switch arrangements that do not enjoy hermetically sealed mercury-wetted contacts.

A variety of embodiments have been discussed. There are a number of possible embodiments for the mass/arm combination so as to include numerous mechanical toggling apparatus. The possibilities discussed above include a mass on a hinged arm and a ball in a track. Alternatives that should be apparent can include arrangements responsive to forces other than gravity alone, such as a magnetic spring loaded arm, wherein the arm has a hysteresis aided by one or more magnets snapping a piezo-strip deflector to one position or another, returning when the motion is reversed.

A prototype device was built and tested in connection with sensing the opening of a suburban type mailbox door. FIGS. 16 and 17 show the specific application of the PC board mounted embodiment to mounting on the inside of a planar member such as a mailbox door to sense when the door is tilted open.

The waveform trace shown in FIG. 14 was developed in the mailbox door embodiment, using care to open the door slowly to avoid influencing the signal by the rate of opening. A large swing output between ground and the V+power supply were obtained from an LDT type sensor measuring about 0.16″×0.25″. This sensor uses 3 mil Mylar beam defining a neutral bending axis and 28 μm PVDF laminated on one side. The output shown was conditioned through a JFET buffer (2N4117A), built onto a small PC board as shown in FIG. 16, holding the sensor, mass, arm, and hinge. The device is also shown installed on a mailbox door in FIG. 17.

The exemplary circuit shown for purposes of illustration is unidirectional, i.e., designed to produce a signal only on the opening of the door. The fundamental design allows bipolar information, that is, a signal when opened, and a signal of the opposite polarity when it is closed.

The parts count to build the prototype is small and the parts are inexpensive, allowing this device to be used in price sensitive applications. The magnitude of the output signal is so large that the signal to noise is very high, ensuring that the device will work under the most adverse conditions of temperature, wind, vibration, and the like.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. An apparatus for developing a signal representing application of a force, comprising:
a movable mass having one of an attractive and a repulsive response to the force, the movable mass being mounted for displacement along a path from a preloaded position to an unloaded position upon application of the force;
a piezoelectric element operable to generate an electrical potential when deflected, the piezoelectric element being mounted so as to be deflected upon displacement of the mass along the path;

2. The apparatus of claim 1, further comprising a mounting structure constraining the movable mass to move between the preloaded position and the unloaded position.

3. The apparatus of claim 2, wherein the mounting structure is arranged to guide the 7 movable mass back from the unloaded position to the preloaded position.

4. The apparatus of claim 3, wherein the mounting structure is arranged to guide the movable mass back from the unloaded position to the preloaded position upon cessation of the force.

5. The apparatus of claim 4, wherein the force is directional and the mounting structure and the force are relatively movably oriented for alternatively directing the mass between the preloaded and unloaded positions.

6. The apparatus of claim 5, wherein the force is inertial and the mounting structure is tiltable relative to a direction of the force.

7. The apparatus of claim 5, wherein the force is gravitational and the mounting structure is tiltable relative to vertical.

8. The apparatus of claim 1, wherein the signal is generated by impact of the movable mass upon acceleration along the path, from the preloaded position, due to the force.

9. The apparatus of claim 1, wherein the movable mass is free falling relative to the piezoelectric element and the signal is generated at least partly by impact of the movable mass against the piezoelectric element.

10. The apparatus of claim 1, further comprising a common support for the movable mass and the piezoelectric element, and wherein the force is applied in the direction of movement by changing an orientation of the support.

11. The apparatus of claim 10, wherein the movable mass is pivoted on the common support to fall against the piezoelectric element.

12. The apparatus of claim 1, wherein the piezoelectric element comprises a resilient strip having a rest position and wherein the movable mass is arranged to bend the resilient strip from the rest position.

13. The apparatus of claim 10, wherein the piezoelectric element comprises a resilient strip having a rest position and wherein the movable mass is arranged to bend the resilient strip from the rest position.

14. The apparatus of claim 12, wherein the movable mass is arranged over a pivot axis, defining an inverted pendulum by which the movable mass is moved between the preloaded position and the unloaded position by overbalancing the pendulum in a plane perpendicular to a pivot axis of the pendulum

15. The apparatus of claim 14, further comprising at least one supplemental extension coupled to the pendulum for affecting movement of at least one of the pendulum and the piezoelectric element upon overbalancing of the pendulum.

16. The apparatus of claim 14, wherein the pendulum is mounted to restrict a range of movement of the mass between the preloaded and the unloaded positions.

17. The apparatus of claim 15, wherein the supplemental extension is positioned to preload the piezoelectric element by bending in a direction opposite from a direction of displacement by the mass.

18. The apparatus of claim 17, wherein the pendulum comprises two angularly spaced legs, one of the legs carrying the mass and another of the legs operating in the preloaded position of the mass to bend the piezoelectric element in said direction opposite from the direction of displacement.

19. The apparatus of claim 15, wherein the supplemental extension comprises a portion extending on an opposite side of the pivot axis from the mass.

20. The apparatus of claim 18, further comprising a mounting base in which the pendulum is movable and wherein the supplemental extension bears against the mounting base in the preloaded position.
